(19) United States
(12) Patent Application Publication
(10) Pub. No.: US 2018/0374373 A1
(43) Pub. Date: Dec. 27, 2018

(54) RECOMMENDING LEARNING ACTIVITIES

(71) Applicant: International Business Machines Corporation, Armonk, NY (US)

(72) Inventors: Evelyn R. Anderson, Houston, TX (US); Natalie N. Brooks Powell, Bolingbrook, IL (US); Kristen N. Conley, Kieler, WI (US); Martin G. Keen, Cary, NC (US)

(21) Appl. No.: 15/910,228

(22) Filed: Mar. 2, 2018

Related U.S. Application Data
(63) Continuation of application No. 15/633,902, filed on Jun. 27, 2017.

(51) Int. Cl. G09B 5/00; G09B 7/06; G06F 17/30

(52) U.S. Cl. CPC G09B 5/00; G06F 17/30991; G09B 7/06

(57) ABSTRACT

Learning activities for a particular topic are identified according to a user profile. The learning activities are identified from resources such as advertised local events, technical publications, social network postings, and related websites. The user profile includes information for selecting a learning activity, such as learning preferences of the user, level of skill in the particular topic, and curriculum in which the user participates.

### BACKGROUND

The present invention relates generally to the field of education technology, and more particularly to identifying appropriate learning activities.

Learning is what prepares young people for meaningful citizenship, employment, post-secondary education, and participation in society. Individuals often process information differently. Every learner displays different preferences for learning and different outcomes based on learning experiences. Most individuals exhibit certain preferences or predispositions for several parameters within a learning ecosystem. Different individuals prefer to learn at different times, different speeds, and different content or different modalities. Some learners may display one of several basic learning styles, e.g., visual, auditory, or kinesthetic learning.

Education is one of the key activities of museums and cultural events, together with keeping, research and presentation of objects and history. Today, with the permanently growing information flow, society needs, more than ever before, to get targeted, verified, and comprehensible information. Museums have been accumulating civilization experience of the humankind for centuries along with universities and scientific and research institutions, represent valuable sources of such information. As a unique intermediary between the object of historical and cultural heritage and recipient of cultural codes, museums and cultural events offer almost unlimited possibilities in the area of education.

### SUMMARY

According to an aspect of the present invention, there is a method, computer program product and/or system for recommending learning activities that performs the following steps (not necessarily in the following order): (i) identifying a specified topic within a curriculum; (ii) generating a user profile for a user registered for the curriculum; (iii) determining a set of research data corresponding to the specified topic; (iv) assigning target characteristics to learning activities in the set of research data; (v) selecting from the set of research data a set of learning activities based on an assigned target characteristic and the user profile; and (vi) reporting to the user a list of learning activities ordered according to a rank. At least the determining and selecting steps are performed by computer software running on computer hardware.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram view of a machine logic (e.g., software) portion of the first embodiment system; and

FIG. 4 is a schematic view of a second embodiment of a system according to the present invention.

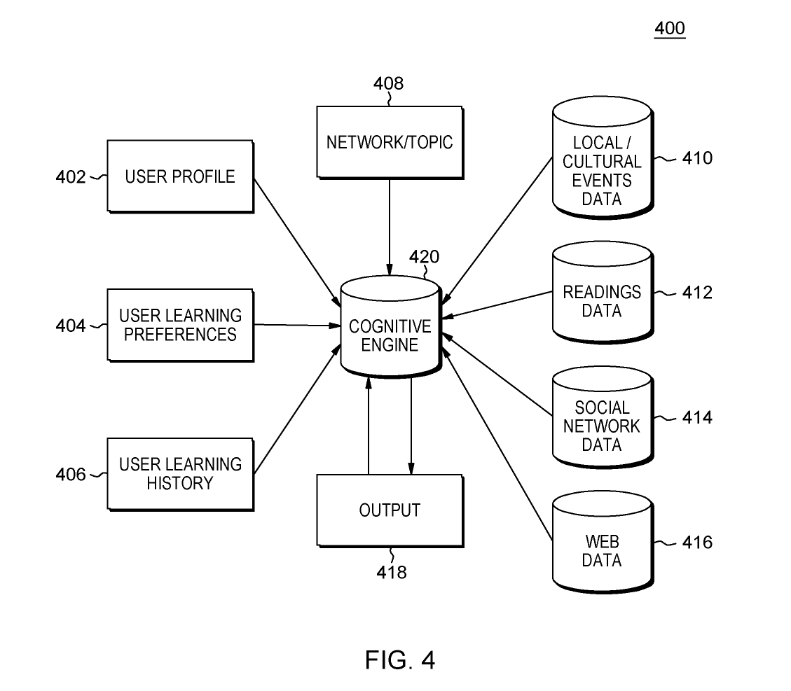

### DETAILED DESCRIPTION

Learning activities for a particular topic are identified according to a user profile. The learning activities are identified from resources such as advertised local events, technical publications, social network postings, and related websites. The user profile includes information for selecting a learning activity, such as learning preferences of the user, level of skill in the particular topic, and curriculum in which the user participates. This Detailed Description section is divided into the following sub-sections: (i) Hardware and Software Environment; (ii) Example Embodiment; (iii) Further Comments and/or Embodiments; and (iv) Definitions.

### I. Hardware and Software Environment

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

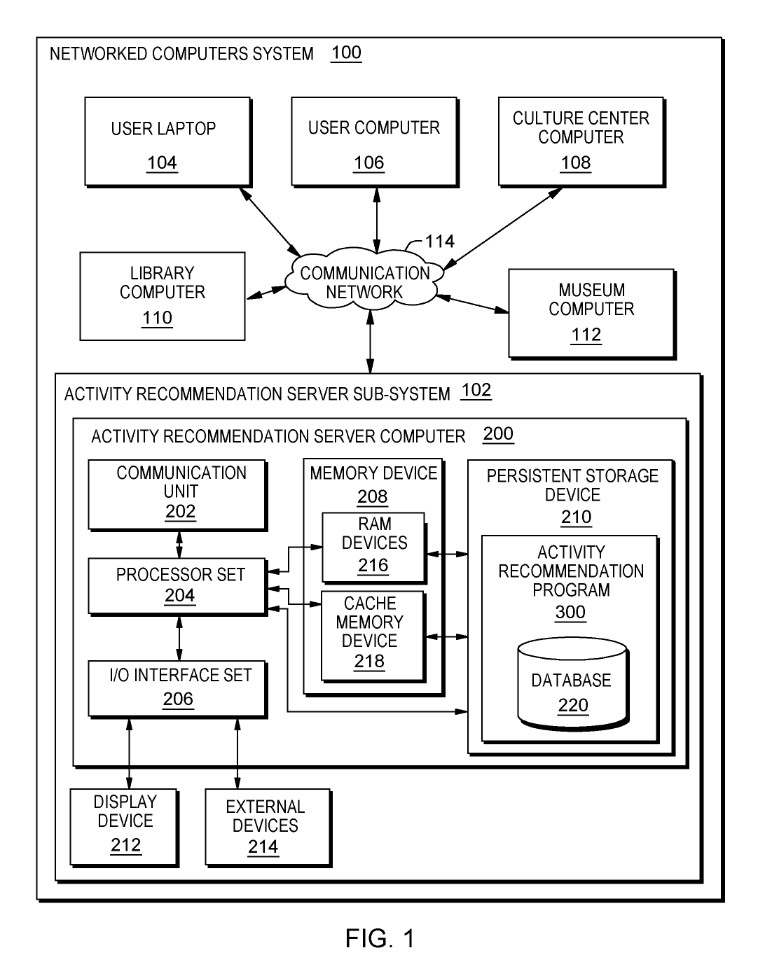

An embodiment of a possible hardware and software environment for software and/or methods according to the present invention will now be described in detail with reference to the Figures. FIG. 1 is a functional block diagram illustrating various portions of networked computers system 100, including: activity recommendation server sub-system 102; user laptop 104, user computer 106, culture center computer 108, library computer 110, museum computer 112; and communication network 114. Activity recommendation server sub-system 102 contains: activity recommendation server computer 200; display device 212; and external devices 214. Activity recommendation server computer 200 contains: communication unit 202; processor set 204; input/output (I/0) interface set 206; memory device 208; and persistent storage device 210. Memory device 208 contains: random access memory (RAM) devices 216; and cache memory device 218. Persistent storage device 210 contains: activity recommendation program 300 and database 220.

Activity recommendation server sub-system 102 is, in many respects, representative of the various computer sub-systems in the present invention. Accordingly, several portions of activity recommendation server sub-system 102 will now be discussed in the following paragraphs.

Activity recommendation server sub-system 102 may be a laptop computer, a tablet computer, a netbook computer, a personal computer (PC), a desktop computer, a personal digital assistant (PDA), a smart phone, or any programmable electronic device capable of communicating with client sub-systems via communication network 114. Activity recommendation program 300 is a collection of machine readable instructions and/or data that is used to create, manage, and control certain software functions that will be discussed in detail, below, in the Example Embodiment sub-section of this Detailed Description section.

Activity recommendation server sub-system 102 is capable of communicating with other computer sub-systems via communication network 114. Communication network 114 can be, for example, a local area network (LAN), a wide area network (WAN) such as the Internet, or a combination of the two, and can include wired, wireless, or fiber optic connections. In general, communication network 114 can be any combination of connections and protocols that will support communications between server and client sub-systems.

Activity recommendation server sub-system 102 is shown as a block diagram with many double arrows. These double arrows (no separate reference numerals) represent a communications fabric, which provides communications between various components of activity recommendation server sub-system 102. This communications fabric can be implemented with any architecture designed for passing data and/or control information between processors (such as microprocessors, communications processors, and/or network processors, etc.), system memory, peripheral devices, and any other hardware components within a system. For example, the communications fabric can be implemented, at least in part, with one or more buses.

Memory device 208 and persistent storage device 210 are computer readable storage media. In general, memory device 208 can include any suitable volatile or non-volatile computer readable storage media. It is further noted that, now and/or in the near future: (i) external devices 214 may be able to supply some, or all, memory for activity recommendation server sub-system 102; and/or (ii) devices external to activity recommendation server sub-system 102 may be able to provide memory for activity recommendation server sub-system 102.

Activity recommendation program 300 is stored in persistent storage device 210 for access and/or execution by one or more processors of processor set 204, usually through memory device 208. Persistent storage device 210: (i) is at least more persistent than a signal in transit; (ii) stores the program (including its soft logic and/or data) on a tangible medium (such as magnetic or optical domains); and (iii) is substantially less persistent than permanent storage. Alternatively, data storage may be more persistent and/or permanent than the type of storage provided by persistent storage device 210.

Activity recommendation program 300 may include both substantive data (that is, the type of data stored in a database) and/or machine readable and performable instructions. In this particular embodiment (i.e., FIG. 1), persistent storage device 210 includes a magnetic hard disk drive. To name some possible variations, persistent storage device 210 may include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage device 210 may also be removable. For example, a removable hard drive may be used for persistent storage device 210. Other examples include optical and magnetic disks, thumb drives, and smart cards that are inserted into a drive for transfer onto another computer readable storage medium that is also part of persistent storage device 210.

Communication unit 202, in these examples, provides for communications with other data processing systems or devices external to activity recommendation server sub-system 102. In these examples, communication unit 202 includes one or more network interface cards. Communication unit 202 may provide communications through the use of either or both physical and wireless communications links. Any software modules discussed herein may be downloaded to a persistent storage device (such as persistent storage device 210) through a communications unit (such as communication unit 202).

I/O interface set 206 allows for input and output of data with other devices that may be connected locally in data communication with activity recommendation server computer 200. For example, I/O interface set 206 provides a connection to external devices 214. External devices 214 will typically include devices, such as a keyboard, a keypad, a touch screen, and/or some other suitable input device. External devices 214 can also include portable computer readable storage media, such as, for example, thumb drives, portable optical or magnetic disks, and memory cards. Software and data used to practice embodiments of the present invention (e.g., activity recommendation program 300) can be stored on such portable computer readable storage media. In these embodiments, the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus, the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

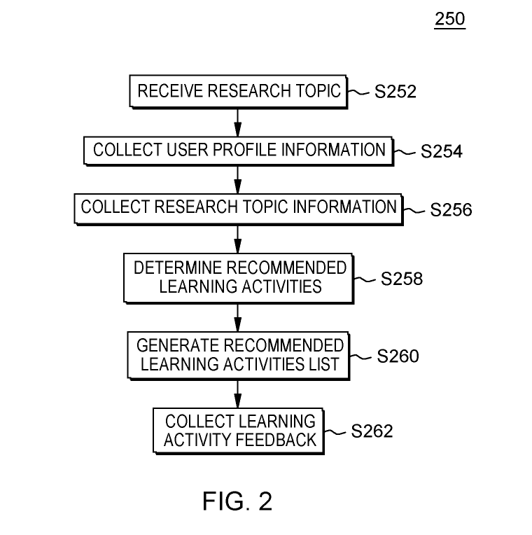

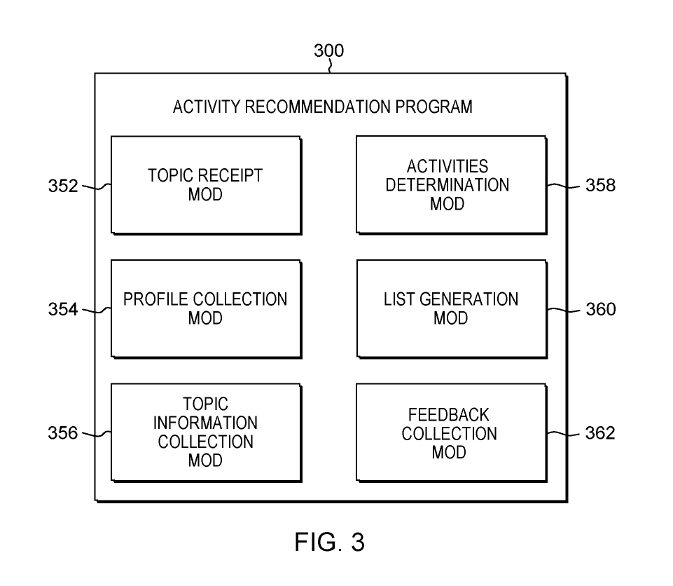

FIG. 2 shows flowchart 250 depicting a method according to the present invention. FIG. 3 shows activity recommendation program 300, which performs at least some of the method operations of flowchart 250. This method and associated software will now be discussed, over the course of the following paragraphs, with extensive reference to FIG. 2 (for the method operation blocks) and FIG. 3 (for the software blocks).

Processing begins at operation S252, where topic receipt module (“mod”) 352 receives a research topic for a user. The research topic may be a topic based on a school curriculum, a school assignment, or for personal knowledge and curiosity. The research topic may be a broad, overarching subject that is part of a curriculum or a specific event or matter. The research topic may be inputted to activity recommendation program 300 by the user, a teacher, a parent or guardian, a family member or friend of the user, or any other relevant third party. The research topic may be inputted with a personal computer (or user laptop 104 and user computer 106 as seen in FIG. 1). In this embodiment, the user Abe is a middle school student given a homework assignment about William Shakespeare, an English poet and playwright. Activity recommendation program 300 may receive the research topic of ‘William Shakespeare’ from Abe's school teacher, from Abe, from Abe's parent, or directly from the assignment sheet given to Abe by his teacher.

Processing proceeds to operation S254, where profile collection mod 354 collects relevant profile information regarding the user. Profile information regarding a user includes statistical data, learning preferences and learning history. Statistical data, such as a user's age may be used to determine age-appropriate activities. For example, a learning activity recommended for a 21-year-old college student would likely be different from a 5-year-old student who does not know how to read yet. Learning preferences are how the user likes to learn new things. This includes a preference to read books about a subject versus a preference to watch videos about a subject. Some people learn better from hands-on activities while other people learn better from observing as a third party. Learning history is how the user is doing in relation to the user's peers and how the user is doing on the subject matter or curriculum. For example, a student who gets good grades on biology exams would likely be recommended more advanced activities versus a student who struggles on biology exams and is behind compared to the student's peers. Profile information may be updated by the user or any relevant third party by a personal computer (or user laptop 104 and user computer 106 as seen in FIG. 1). In this embodiment, activity recommendation program 300 collects user profile information about Abe. Activity recommendation program 300 collects Abe's age (13 years old), collects that Abe prefers watching or experiencing things rather than reading about them, and that Abe is an average student in the subjects of literature, which is the subject matter Shakespeare falls under.

Processing proceeds to operation S256, where topic collection mod 356 collects information regarding the research topic. The information regarding the research topic includes local and cultural events data, readings data, social network data, and web data as well as material relevant to the curriculum. Activity recommendation program 300 collects data on information to find activities relevant to the research topic and stores in database 220, as seen in FIG. 1. Local and cultural events data includes data from shows, fairs, museums, culture centers, restaurants, and other public events in a particular area. Due to users likely enjoying events and activities close to them, cultural data would be limited to those that are in reasonable proximity to the user. Activity recommendation program 300 may retrieve this information from computers, databases or servers storing information on these events such as culture center computer 108 and museum computer 112 as seen in FIG. 1. Readings data includes books, magazine articles, newspaper articles, publications, and other literature relevant to the research topic. Activity recommendation program 300 may retrieve this information from computers, databases or servers storing information from libraries such as library computer 110 as seen in FIG. 1. Social network data includes data retrieved from social networking websites that have posted events or information regarding the research topic. Web data includes websites relevant to the research topic. Activity recommendation program 300 may retrieve this social network data and web data from a personal computer such as user laptop 104 and user computer 106 as seen in FIG. 1. Additionally, feedback given from previous learning activities are collected by activity recommendation program 300. In this embodiment, activity recommendation program 300 collects information relevant to Shakespeare. Local events data collected by activity recommendation program 300 include a Shakespeare production play of “Hamlet”, an exhibit at a local museum regarding Shakespeare, and a Renaissance fair in a nearby town. Readings data collected by activity recommendation program 300 include literary works by Shakespeare as well as biographies about Shakespeare found in the local public library. Social network events data collected by activity recommendation program 300 include a student production play of “Romeo and Juliet” and a lecture at a nearby university by a Shakespeare scholar. Web data collected by activity recommendation program 300 include websites analyzing Shakespeare's works.

Processing proceeds to operation S258, where activities determination mod 358 determines recommended learning activities for the user. Activity recommendation program 300 uses the user profile information and research topic information to determine recommended activities via machine learning and pattern recognition techniques, as would be appreciated by one with skill in the art. Machine learning explores the study and construction of algorithms that can learn from and make predictions based on data. Such algorithms operate by building a model from example inputs in order to make data-driven predictions or decisions expressed as outputs, rather than following strictly static program instructions. Within the field of data analytics, machine learning is a method used to devise complex models and algorithms that lend themselves to decisions, and probability related prediction. These analytical models enable researchers, data scientists, engineers, and analysts to produce reliable, repeatable decisions and results and to uncover hidden insights through learning from historical relationships and trends in the data. Pattern recognition is a branch of machine learning that focuses on the recognition of patterns and regularities in data. Pattern recognition systems may be trained from labeled “training” data (supervised learning), but when no labeled data are available, other algorithms can be used to discover previously unknown patterns (unsupervised learning). The research topic information that is compiled by activity recommendation program 300 are sorted with descriptive tags that identify the type of activity and the target audience of the activity. These tags define a characteristic of the learning activity. For example, some activities might be tagged for all ages while others might be tagged for those over the age of 21. Similarly, some events might be tagged as a reading activity while others might be tagged as a hands-on activity. The user's age, learning preferences and learning history is used to sort through the research topic information to find recommended activities for a particular user. For example, activity recommendation program 300 may detect that the user prefers hands-on activities and would recommend a more hands-on activity for the user. In another example, activity recommendation program 300 may detect that the user is advanced in the subject of science due to the user's high grades in science courses and would recommend a more advanced learning activity for the user. In another example, activity recommendation program 300 may recommend certain activities because how relevant the activity is to the research topic. Learning activities also contain geographic data, scheduling data, and skill level data to better fit a user's needs. In this embodiment, activity recommendation program 300 recommends the Shakespeare production play of “Hamlet” by a local theater troupe, attending the Renaissance fair in a nearby town, and the student production play of “Romeo and Juliet” over the other activities based on Abe's age, learning preferences and learning history. Abe is an average middle school student who prefers watching or experiencing things rather than reading about them. Activity recommendation program 300 does not recommend reading Shakespeare plays, biographies, or analyses of Shakespeare plays as they are likely too advanced for an average middle school student Similarly, the lecture by a Shakespeare scholar, which was designed for college students, would likely not be age-appropriate for a 13-year old middle school student such as Abe.

Processing proceeds to operation S260, where list generation mod 360 generates a recommended learning activities list for the user. Based on the recommended learning activities, activity recommendation program 300 lists the learning activities along with details of the activities. The list may be ordered to rank activities based on recommendation. Learning activities are ranked relative to other learning activities based on a degree of correlation between the learning activity and the user profile information. The characteristics of the learning activity are factored into the ranking similarly. In this embodiment, activity recommendation program 300 generates a list containing the Shakespeare production play of “Hamlet” by a local theater troupe, attending the Renaissance fair in a nearby town, and the student production play of “Romeo and Juliet” for Abe. The list also contains details of the times and venues of the activities to assist Abe with attending the activities. The list ranks the production play of “Hamlet” as the most recommended learning activity, followed by the student production play of “Romeo and Juliet”, and the Renaissance fair. The list was ranked based on Abe's user profile information and how relevant the activity is to the research topic. For example, the Renaissance fair is not as relevant of an activity to Shakespeare as attending a production of a Shakespeare play.

Processing proceeds to operation S262, where feedback collection mod 362 collects feedback from learning activities from the user. Learning activities that have been attended or utilized by users may be given feedback by the users. Feedback is used to teach the cognitive system to better recommend activities. The feedback is another factor along with the user's profile information to sort the research topic information. The feedback acts as a rating system that is collected with the research topic information of S256. Positively reviewed activities are recommended more often than negatively reviewed activities. For example, a hands-on activity that is recommended for a 10-year-old student that is reviewed positively may be more likely to be recommended to a similar user as the 10-year-old student. In this embodiment, Abe attends the production play of “Hamlet” and the Renaissance fair. Abe rates the production play of “Hamlet” as a negative experience and the rates the Renaissance fair as a very positive experience. For a similar user as Abe, activity recommendation program 300 may not recommend the production play of “Hamlet” as much and may recommend the Renaissance fair more based on the acquired feedback from Abe.

### III. Further Comments and/or Embodiments

Some embodiments of the present invention recognize the following facts, potential problems, and/or potential areas for improvement with respect to the current state of the art. Learning is what prepares young people for meaningful citizenship, employment, post-secondary education, and participation in society. However, after working a full-time job parents often come home with very little time to reinforce learning opportunities in children providing deeper authentic examples (something the children can relate to) making real life connections. Making this lasting learning opportunity allows children to recall the facts later. For example, if a child was learning about money, a parent should take them to the store to allow them to use money to purchase something which would deepen the child's understanding. However, there are topics that parents often find themselves not knowing too much about. Parents have very limited time to do hours of research.

FIG. 5 is a schematic view of computer system 400 including a main controller, or cognitive engine, according to the present disclosure. The computer system includes: user profile 402; user learning preferences 404; user learning history 406; homework/topic 408; local/cultural events data 410; readings data 412; social networking data 414; web data 416; output 418; and cognitive engine 420.

The cognitive engine 420 is trained by both parents, librarians, and educators using social network data 414, local/cultural events data 410, readings data 412, and web data 416. Social network data 414 consists of posts that are relevant to a topic. Local cultural events data 410 consists of analytical insights for local and cultural events in the area. Readings data 412 consists of recommended books and other literature on the topics recommended by librarians. Web data 416 consists of information on various web sites.

Information regarding a user includes user profile 402, user learning preferences 404, and user learning history 406. The system stores one of many user's information including age, user learning preferences, and user's learning history (such as previous grades). This information can be updated by the user based on previous learning activity information. Homework/topic 408 is the topic the user is looking to get more information and knowledge about.

Some embodiments of the present invention may include one, or more, of the following features, characteristics, and/or advantages. This embodiment proposes a cognitive method that creates effective and level appropriate extended learning opportunities for parents to assist in enriching their children through academics, cultural activities or recreational opportunities that guide and engage children in learning providing authentic uses that allow children to secure the knowledge into a life-long skill.

### IV. Definitions

“Present invention” does not create an absolute indication and/or implication that the described subject matter is covered by the initial set of claims, as filed, by any as-amended set of claims drafted during prosecution, and/or by the final set of claims allowed through patent prosecution and included in the issued patent. The term “present invention” is used to assist in indicating a portion or multiple portions of the disclosure that might possibly include an advancement or multiple advancements over the state of the art. This understanding of the term “present invention” and the indications and/or implications thereof are tentative and provisional and are subject to change during the course of patent prosecution as relevant information is developed and as the claims may be amended.

“Embodiment,” see the definition for “present invention.”

“And/or” is the inclusive disjunction, also known as the logical disjunction and commonly known as the “inclusive or.” For example, the phrase “A, B, and/or C,” means that at least one of A or B or C is true; and “A, B, and/or C” is only false if each of A and B and C is false.

A “set of” items means there exists one or more items; there must exist at least one item, but there can also be two, three, or more items. A “subset of” items means there exists one or more items within a grouping of items that contain a common characteristic.

A “plurality of” items means there exists at more than one item; there must exist at least two items, but there can also be three, four, or more items.

“Includes” and any variants (e.g., including, include, etc.) means, unless explicitly noted otherwise, “includes, but is not necessarily limited to.”

A “user” or a “subscriber” includes, but is not necessarily limited to: (i) a single individual human; (ii) an artificial intelligence entity with sufficient intelligence to act in the place of a single individual human or more than one human; (iii) a business entity for which actions are being taken by a single individual human or more than one human; and/or (iv) a combination of any one or more related “users” or “subscribers” acting as a single “user” or “subscriber.”

The terms “receive,” “provide,” “send,” “input,” “output,” and “report” should not be taken to indicate or imply, unless otherwise explicitly specified: (i) any particular degree of directness with respect to the relationship between an object and a subject; and/or (ii) a presence or absence of a set of intermediate components, intermediate actions, and/or things interposed between an object and a subject.

A “module” is any set of hardware, firmware, and/or software that operatively works to do a function, without regard to whether the module is: (i) in a single local proximity; (ii) distributed over a wide area; (iii) in a single proximity within a larger piece of software code; (iv) located within a single piece of software code; (v) located in a single storage device, memory, or medium; (vi) mechanically connected; (vii) electrically connected; and/or (viii) connected in data communication. A “sub-module” is a “module” within a “module.”

A “computer” is any device with significant data processing and/or machine readable instruction reading capabilities including, but not necessarily limited to: desktop computers; mainframe computers; laptop computers; field-programmable gate array (FPGA) based devices; smart phones; personal digital assistants (PDAs); body-mounted or inserted computers; embedded device style computers; and/or application-specific integrated circuit (ASIC) based devices.

“Electrically connected” means either indirectly electrically connected such that intervening elements are present or directly electrically connected. An “electrical connection” may include, but need not be limited to, elements such as capacitors, inductors, transformers, vacuum tubes, and the like.

“Mechanically connected” means either indirect mechanical connections made through intermediate components or direct mechanical connections. “Mechanically connected” includes rigid mechanical connections as well as mechanical connection that allows for relative motion between the mechanically connected components. “Mechanically connected” includes, but is not limited to: welded connections; solder connections; connections by fasteners (e.g., nails, bolts, screws, nuts, hook-and-loop fasteners, knots, rivets, quick-release connections, latches, and/or magnetic connections); force fit connections; friction fit connections; connections secured by engagement caused by gravitational forces; pivoting or rotatable connections; and/or slidable mechanical connections.

A “data communication” includes, but is not necessarily limited to, any sort of data communication scheme now known or to be developed in the future. “Data communications” include, but are not necessarily limited to: wireless communication; wired communication; and/or communication routes that have wireless and wired portions. A “data communication” is not necessarily limited to: (i) direct data communication; (ii) indirect data communication; and/or (iii) data communication where the format, packetization status, medium, encryption status, and/or protocol remains constant over the entire course of the data communication.

The phrase “without substantial human intervention” means a process that occurs automatically (often by operation of machine logic, such as software) with little or no human input. Some examples that involve “no substantial human intervention” include: (i) a computer is performing complex processing and a human switches the computer to an alternative power supply due to an outage of grid power so that processing continues uninterrupted; (ii) a computer is about to perform resource intensive processing and a human confirms that the resource-intensive processing should indeed be undertaken (in this case, the process of confirmation, considered in isolation, is with substantial human intervention, but the resource intensive processing does not include any substantial human intervention, notwithstanding the simple yes-no style confirmation required to be made by a human); and (iii) using machine logic, a computer has made a weighty decision (for example, a decision to ground all airplanes in anticipation of bad weather), but, before implementing the weighty decision the computer must obtain simple yes-no style confirmation from a human source.

“Automatically” means “without any human intervention.”

The term “real time” (and the adjective “real-time”) includes any time frame of sufficiently short duration as to provide reasonable response time for information processing as described. Additionally, the term “real time” (and the adjective “real-time”) includes what is commonly termed “near real time,” generally any time frame of sufficiently short duration as to provide reasonable response time for on-demand information processing as described (e.g., within a portion of a second or within a few seconds). These terms, while difficult to precisely define, are well understood by those skilled in the art.

What is claimed is:

1. A method for recommending learning activities, the method comprising:
identifying a specified topic within a curriculum;
generating a user profile for a user registered for the curriculum, the user profile including statistical data, learning preferences, and learning history associated with the user;
determining curriculum materials, public events, publications, websites, and social networks corresponding to the specified topic;
assigning geographic data, scheduling data, and skill level data to learning activities in the set of research data;
selecting from the set of research data a set of learning activities based on an assigned target characteristic and the user profile;
reporting to the user a list of learning activities ordered according to a rank based on a degree of correlation between the assigned target characteristics of each learning activity and the user profile;
for each learning activity, assigning the rank relative to other learning activities in the set of learning activities;
collecting feedback for learning activities on the list of learning activities; and
implementing a set of learning activities based on the feedback;
wherein: the feedback is generated by the user according to a rating system for the learning activities; and
selecting another set of learning activities responsive to the feedback.
